(19) United States
(12) Patent Application Publication
(10) Pub. No.: US 2010/0318233 A1
(43) Pub. Date: Dec. 16, 2010

(54) REMOTE ENERGY MONITORING AND REPORTING SYSTEM

(76) Inventors: Yuki Yunes, Vernal, UT (US); Yuji Yunes, Vernal, UT (US); Brett Haslem, Vernal, UT (US)

Correspondence Address: BATEMAN IP LAW GROUP, P.O. BOX 1319, SALT LAKE CITY, UT, 84110, US

(21) Appl. No.: 12/765,730

(22) Filed: Apr. 22, 2010

Related U.S. Application Data
(60) Provisional application No. 61/171,776, filed on Apr. 22, 2009.

(51) Int. Cl. G06F 1/28

(52) U.S. Cl. 700/287; 700/292

(57) ABSTRACT

A complete system that will enable remote monitoring of the status (e.g. power generation, power consumption, system faults, etc.) of renewable energy units is disclosed. The system is a stand-alone data acquisition module with a web based user interface that will display information regarding the status of the system under observation. The system may help optimize the return on investment to companies relying on renewable energy at remote locations such as gas and oil production wells regardless of the setup and brand of products used at the remote site.

### PRIORITY

The present application claims the benefit of U.S. Provisional Application Ser. No. 61/171,776, filed Apr. 22, 2009, which is herein incorporated by reference in its entirety.

### THE FIELD OF THE INVENTION

The present invention relates to systems and associated methods for monitoring remote power generation systems. More particularly, the present invention relates to system and associated methods for monitoring remote power generation systems for gas or oil wells, including remote communication to convey data related to the power generation systems for the gas or oil wells.

### BACKGROUND

Many oil and gas wells are located in various remote places without access to electricity. Monitoring of these remote wells to determine the production and status of the remote wells is critical to efficient production of those wells.

Solar and wind driven power generation has been used at the remote wells to enable the wells to communicate information to well monitoring stations through radio frequencies. Currently, when a well fails to communicate with the well monitoring station, the nature of the failure is unknown. The power generator may have failed, the well may have failed, or the well communication system may have failed.

Because the nature of the failure is generally unknown, a service visit must be made to the remote well location with preparation and equipment to fix a wide array of potential problems, rather than a technician being prepared for a specific known problem. This may result in various problems. The technician may not be prepared to fix the particular problem when they have reached the well, resulting in additional repair time to address the particular problem and additional down time for the well. It is appreciated that the lost revenues from a non-functioning well may be significant. The service technician also loses time in unnecessarily preparing for and bringing supplies to fix potential problems which have not actually occurred. Similarly, the costs of sending a repair vehicle with a large amount of supplies and equipment are also expensive.

Without specific information about the actual system status, including the wear, capacity, or failure of individual components such as the batteries, solar panels, wind turbines, etc., routine maintenance or component replacement may also be inefficient because the maintenance may be too frequent, or not frequent enough. Too frequent replacement of components increases the cost of the system, and too infrequent maintenance often results in component failure, causing repair trips and lost well production. In some cases, the individual trained to maintain the well may be different than the person trained to maintain the well communication system, or the remote power generation system, causing further losses when the incorrect repair person is sent, or in time lost by sending an individual to identify the problem and then send the appropriate personnel and equipment to repair the respective non-functioning part or system.

### SUMMARY OF THE INVENTION

Exemplary remote power monitoring systems and associated methods are disclosed. The exemplary monitoring system is used with remote power generation systems such as solar cells and/or wind turbines, and incorporates real time data such as power usage, power generation, and changes in power usage or power generation which may be analyzed to determine performance of the power generation system.

According to some aspects of the invention, the real time data and system information may be used to reflect the physical environment of the systems location. For example, levels of power generation may indicate the weather of the system location, but may also be correlated with known weather conditions in order to determine the cleanliness of the solar cells or the functionality of wind turbines, etc. Similarly, depending on particular needs, a number of environmental variables can be measured in order to optimize the decision making part of the system. For example, average power generation capacity may be compared to the actual energy used to determine correct sizing of systems for that location. This data may be helpful for future installations and for initiating preventative actions such as maintenance.

Past and present performance of the system can be compared for making educated decisions involving time of the year when the most problems tend to occur, and what causes those problems. According to another aspect of the power management system, the management system sends messages to designated persons about system performance. These messages are often sent as e-mail alerts in order to alert a user who is responsible for monitoring the system, as well as users in the field, and may be used to let them know when a problem is occurring or is expected to occur. Problems which may be reported may include the charge controller not charging, battery bank level low, battery bank level critical, with this consumption rate your system will be out of power in 14 hours, etc. Given this information the system or users may prioritize deployment of resources to repair or maintain various remote systems if multiple problems are occurring at the same time.

These and other aspects of the present invention are realized in a remote energy monitoring system as shown and described in the following figures and related description.

### BRIEF DESCRIPTION OF THE DRAWINGS

Various embodiments of the present invention are shown and described in reference to the numbered drawings wherein:

FIG. 1 shows a schematic illustrations of embodiments of a remote power monitoring system;

FIG. 2 illustrates an exemplary user interface for a remote power monitoring system; and

FIG. 3 illustrates another exemplary user interface for a remote power monitoring system of the present invention.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

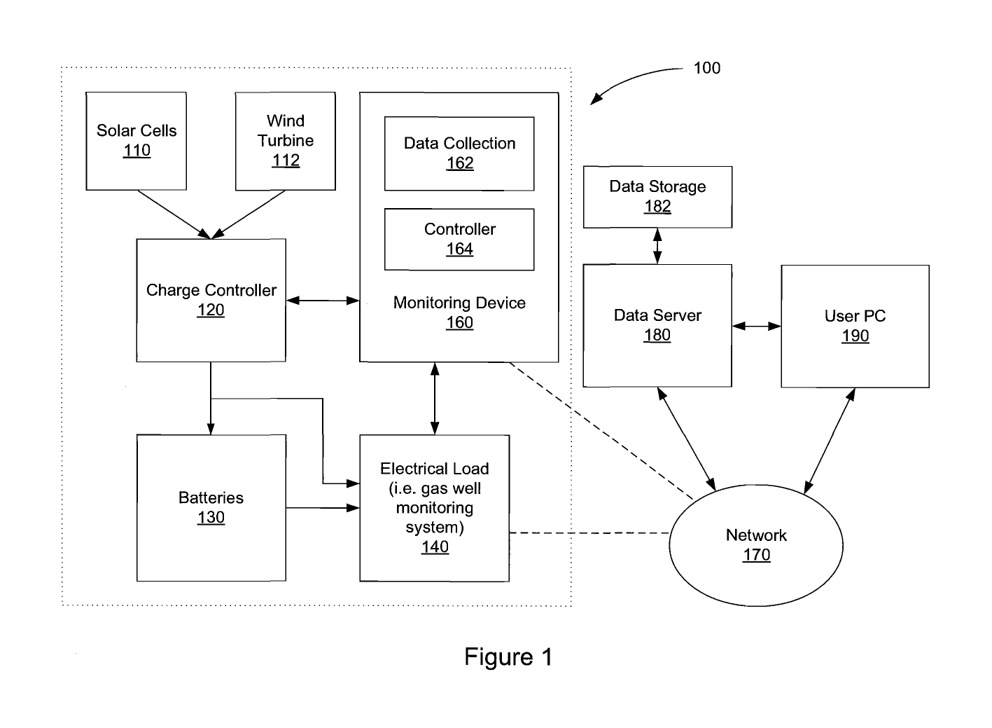

FIG. 1 shows a schematic view of a remote power management system 100. Power management system 100 may include power generation elements, such as a photovoltaic (PV) array 110 (i.e. solar cells) or wind turbine 112, and typically also includes a charge controller 120, and batteries 130. An electrical load device 140, which is typically an oil or gas well and a monitoring device 160 are connected to the power supply, and are typically also connected to a computer network 170 to thereby transmit data to a data processor 180 and user PC 190. Power generation elements, such as PV array 110 or wind turbine 112 may be any size or combination depending on the power requirements of electrical load device 140, location characteristics (average wind, average sun exposure, etc.), and design preferences.

The charge controller 120 is of sufficient size for the power generation elements and the batteries 130. The charge controller 120 controls power storage from the power generation elements to batteries 130, and may also provide power directly to electrical load device 140 when electrical generation is occurring. Charge controller 120 also provides power and system information to monitoring device 160.

Batteries 130 store electricity for later use when the power generation elements may not be producing energy. Batteries 130 may be sized to provide power required by electrical load device 140 to run for a desired amount of time without additional power generation. For example, in some remote locations, there may be only a few hours of effective solar power generation from PV array 110 on a given day. PV array 110 would be sized to generate enough electricity to run electrical load device 140 for at least the time between the active solar periods.

Electrical load device 140 may be a remote device or system, such as a natural gas or oil well. Remote natural gas wells often use a radio communication device to relay production information. The radio communication device requires power to broadcast the production information at the intervals or times desired by the well managers. Because of the often remote nature of electrical load device 140, no wired connection to the power grid or other wired communication connection may be practical as tens or hundreds of miles of wire may be required for a single remote well.

Turning to the monitoring device 160, the monitoring device 160 may include a data collection module 162 and controller 164. Monitoring device 160 may sample data from: PV array 110 and/or wind turbine 112, including the amount of power harvest by the renewable energy system; batteries 130, including the amount of power stored in the renewable energy system; electrical loads from electrical load device 140, including the amount of power consumed; environmental variables, such as solar radiation, ambient temperature sensors, wind speed & direction and humidity, which may be useful for understanding the system status.

Data collection module 162 may be connected to the various sensors, charge controller 120, batteries 130, electrical load device 140, or any combination of these elements, as required to collect the desired data and information. In some embodiments, charge controller 120 may be sophisticated enough that all power-related information may be accessible through charge controller 120 without necessity of connecting directly to other components of the power generation system for desired information. According to one embodiment of the system, the monitoring device 160 utilizes sensors which obtain the relevant information about the various system components without requiring a data interface with the component itself. This is to say that the system includes sensors such as voltage and current sensors which can monitor the performance of the power generation devices or batteries without requiring a data interface with the charge controller that provides this information. The use of discrete sensors rather than relying on the charge controller allows the monitoring device 160 to be used in combination with any type of power generation devices and charge controllers rather than relying on a charge controller to provide operating information about the system.

Controller 164 may include on-site data storage for data backup in case of a data transfer failure. Controller 164 may include a single board controller with a microprocessor, memory, and data storage sufficient to allow data analysis, as desired. Similarly, on-site display of the current system status and alarms may be available as desired, for example with a display connected to a single board controller. Controller 164 may be used to determine on-site the average power usage and generation, the historical performance of the power generation system, and may identify and determine likely and upcoming failures, including the type and mode of failure, and the type and mode of current failures.

Additionally, monitoring device 160 may use the information to determine a likely time of failure. For example, if power generation is decreasing, monitoring device 160 may be able to predict when system 100 will no longer have the power sufficient to function. Similarly, the monitoring device 160 may track the performance of individual components of the system such as the solar cells or batteries and determine when a particular component will no longer function at a sufficient level to allow the system 100 to operate properly. Monitoring device 160 may then generate a warning indicating the performance decline and likely failure date. In another example, a storm may cause PV array 110 to be covered with dust, dirt or snow, reducing the ability of PV array 110 to collect power, which may result in a warning that further power collection may be limited and that failure is imminent upon consumption of the power in batteries 130. The monitoring device 160 may compare the output of the power generation devices to measured environmental conditions in order to determine if the power generation devices are operating properly, such as by comparing output from a solar cell array with sensed light levels. Of course, other failures and events may provide information for generation of a warning by monitoring device 160. Information from monitoring device 160 may be used to deploy a repair or maintenance person with the appropriate information to efficiently correct or prevent a failure of system 100 or any of its components.

Monitoring device 160 may be able to connect to network 170 to convey warnings, failure notices, data, or other information about the performance of the power generation system. Network 170 may be accessed by monitoring device 160 through Wi-Fi, 3G, or any known data communications technology or data communications protocol. For example, monitoring device may have a 3G wireless communication device that may be used to access data server 180 through the internet to convey information about the system 100. Monitoring device 160 may be in constant communication with the data server 180, or may communicate with data server 180 on a schedule, or when a warning or failure notice is generated by the monitoring device 160.

User PC 190 may be used to access data server 180 or monitoring device 160 to review the performance of system 100. User PC 190 may also be used to update the software, or to turn on/off different features of monitoring device 160. Similarly, monitoring device 160 may be upgraded or serviced on-site. The data server 180 of the user PC computer 190 may also be used to analyze the data which is received from the monitoring device 160. The data server 180 or user PC 190 may compare the output of the power generation devices with expected weather conditions to determine whether the power generation device is functioning properly.

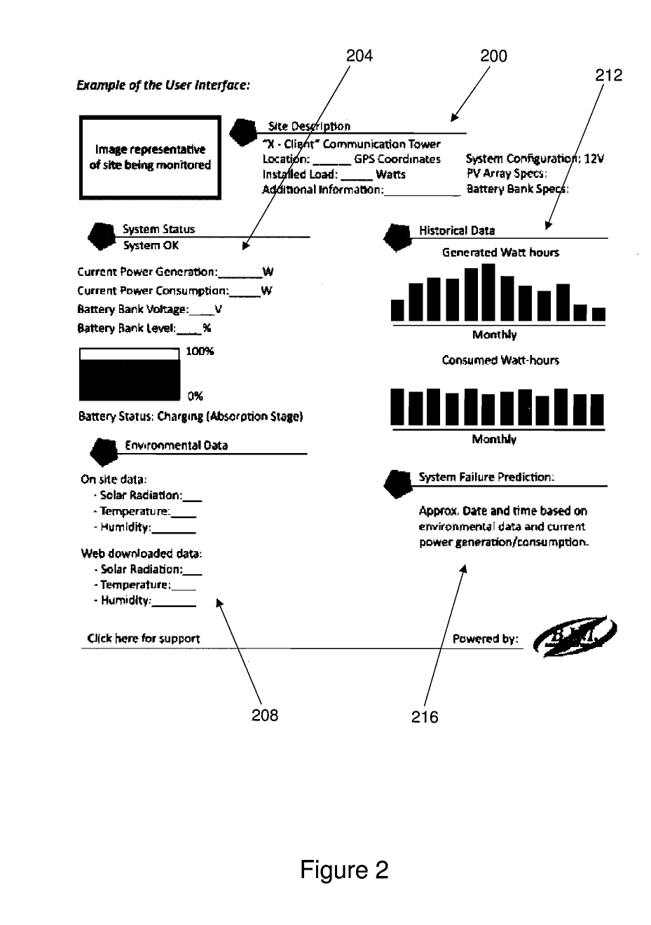

When several remote systems 100 have problems or identify future failures or problems, data server 180 or user PC 190 may be used to prioritize the service order for remote sites to reduce or eliminate potential down-time for each remote site. User PC 190 access to data for each monitoring device 160 may be web-based. An example of a user interface screen is shown in FIG. 2. FIG. 2 illustrates various different types of information which may be presented to a user to allow them to manage the power system 100 and the controlled device 140, such as the gas or oil well. The user interface may include a description of the controlled device 200, which can include information about the site location, the type of controlled device, the operational load of the controlled device, and the types of system components used to power the controlled device and monitoring device 160. The user interface may also show the system status 204, showing information such as the current power generation and consumption, battery bank storage level and voltage, and the battery status. The interface may also show environmental data 208, such as measured environmental data and internet downloaded environmental data and weather conditions. Conditions such as solar radiation, temperature, humidity, and wind may be measured or downloaded and used to predict the electricity production levels for the solar array 110 or wind turbines 112, and may be used to determine if these power generation devices are operating properly or are operating inefficiently. The monitoring device 160 may determine and track the efficiency level at which the power generating devices are operating and determine when the devices will no longer supply the necessary energy and need replacement. The monitoring device 160 may also be used to determine if damage to the power generation devices has occurred based on a drop in the efficiency of the device. The user interface may also include historical data such as the watt-hours of electricity generated by the solar array or wind turbine and the watt-hours of power consumed by the controlled device 140. The user interface may also include predicted maintenance 216 such as a predicted replacement date for a component which is expected to fail. As discussed, the predicted failure date of a component may be based on the historical data of the component's operational status.

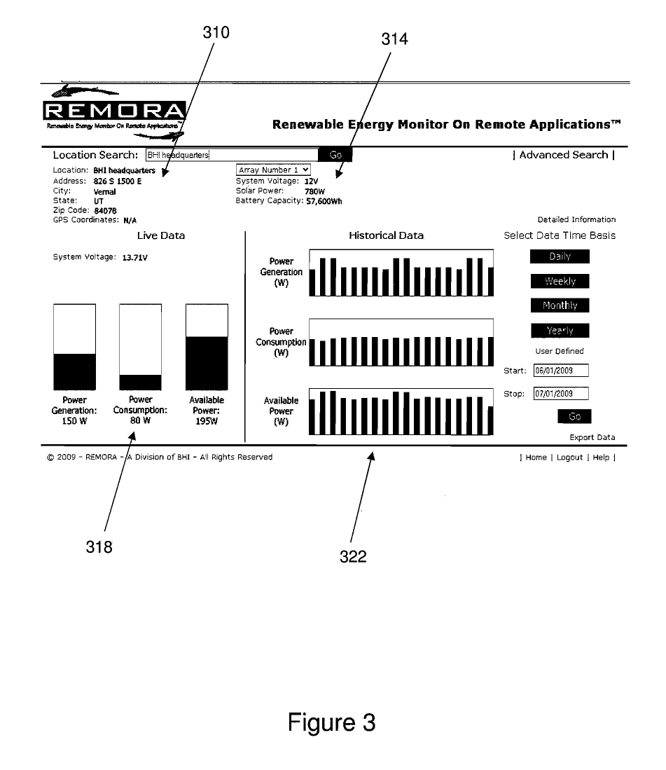

FIG. 3 shows another exemplary user interface. The user interface shown in FIG. 3 contains similar information to that shown in FIG. 2. The user interface may include site information 310 where a power management system is installed. This may include the location of the system. The interface may also show the type of system which is installed 314, including, for a selected power array, the system design voltage, solar power capacity, and battery capacity. The interface may also show current system data 318, such as current power generation and consumption and the available power capacity of the battery bank. The interface may also show the historical system information 322, such as the power generation, consumption, and capacity for a selected time period. The user interface may also be customizable to show the other data discussed above.

As discussed, a significant advantage of the present control system is the ability to integrate the control functions of the electrical system and to predict and schedule system maintenance and component replacement. The monitoring device 160 is able to measure the performance of the power generation devices 110, 112, monitor the charge controller, monitor the status of the battery bank, and monitor the usage of the controlled device 140. All of this data is used together to track the system performance and to determine if the performance of the system is declining or if the performance of individual components of the system is declining.

The monitoring device 160 includes the sensors needed to measure the different physical variables of each system component such as the voltage and current along with sensors to measure actual site weather data. The monitoring device 160 has the capability of storing the data, processing the data and transmitting the data to a dedicated server 180.

The server 180 can be installed remotely at an office location and is responsible for storing the data collected from all of the sensors located throughout the field and that are associated with that particular server. The server can service multiple different energy management systems 100, and as such multiple different monitoring devices 160. The server 180 will have database storage 182 and will also run as the web server to convey the information for remote users that have access to the internet and have the proper authorization to access the data.

The monitoring device 160 is able to acquire data from all components in the system 100, track the performance of the system and individual components, determine if a component is not functioning properly, schedule maintenance, predict system failures, and send messages to the right person in order to allocate the necessary resources to solve the problem promptly and with minimal to no downtime.

Different alarms can be generated, typically as email notifications or text messages, to notify the right person when a problem arises. These messages are sent via e-mail, text, phone, etc. Due to historical data that is recorded, the system can predict any downfall or system malfunction or maintenance, as well as battery life expectancy and when a component may need replacement depending on their performance.

Data storage 182 may be web-server based in which all of the data from every site using a monitoring device 160 will be stored and used for display and analysis. This information may be accessed as desired.

Users accessing information for each site using monitoring device 160 may access: site description, which may include the site location with GPS coordinates, system capacity installed, contact info of the staff responsible for the site, among others; current site status, which may include the power harvest, power consumed, battery levels, alarms, estimated failure prediction, e-mail alerts, among others; historical data, which may display all of the data recorded for the site in a bar graph format for whatever period of time is selected.

In some embodiments, monitoring device 160 may also be used to transmit information about electrical load device 140. For example, electrical load device 140 may be a gas production well that communicates the volume of gas produced and other operational information periodically to a monitoring location. The gas production and well information may be transmitted along with the status of the electrical generation system and other desired information through the connection between monitoring device 160 and user PC 190.

The disclosed embodiments, systems, and associated methods of use are exemplary and are not intended to specifically outline each and every embodiment contemplated by this application. Those skilled in the art will appreciate numerous modifications which can be made in light of the present disclosure that do not depart from the scope of the invention. The appended claims are intended to cover such modifications.

What is claimed is:

1. A remote power monitoring system, comprising:
a power generation system, including
at least one of a PV array and a wind turbine, and
a charge controller;
an electrical load device coupled to a configured to use power from the power generation system; and
a monitoring device attached to the power generation system, and configured to monitor the condition of the power generation system and wirelessly communicate information related to the power generation system to a remote computer.

2. The system of claim 1, wherein the electrical load device is a portion of a natural gas or oil production well.

3. The system of claim 1, wherein the monitoring device tracks operational parameters of the power generation system and is configured to predict component failure of the power generation system.

4. The system of claim 1, further comprising weather sensors.

5. The system of claim 4, wherein the system correlates weather information from the weather sensors to the output of the at least one of a PV array and wind turbine to determine the performance of the at least one of a PV array and wind turbine.

6. The system of claim 1, wherein the system further comprises a communication device for transmitting a message to a predetermined person, the message containing information about system component failure.

7. A power monitoring system comprising:
a power generation device for generating power from at least one of sunlight and wind;
a battery;
a charge controller for charging the battery with power generated from said power generation device;
a controlled device operated by power from at least one of the batter and the power generation device;
a monitoring device, the monitoring device comprising sensors for monitoring the status of the power generation device and the battery;
and a communication device for sending messages to a user, the messages indicating the need to perform maintenance on the monitoring system.

8. The system of claim 7, wherein the controlled device is a natural gas or oil well.

9. The system of claim 7, wherein the monitoring device receives weather information and compares the operation of the power generation device to the weather information to determine if the power generation device is operating properly.

10. The system of claim 9, wherein the monitoring device has weather sensors to thereby receive weather information.

11. The system of claim 7, wherein the system comprises a computer disposed in a different location that the monitoring system, and wherein the monitoring device transmits system operational data to the computer.

12. The system of claim 7, wherein the monitoring device tracks degradation in the performance of the power generation device and predicts failure of the power generation device thereby to schedule maintenance of the power generation device.

13. The system of claim 7, wherein the monitoring device tracks degradation in the performance of the battery and predicts failure of the battery thereby to schedule maintenance of the battery.

14. The system of claim 7, wherein the monitoring device tracks the performance of the components of said system to thereby determine degradation of the performance of said components.

15. The system of claim 14, wherein the monitoring device transmits a message to a person to indicate degradation of the components of the system and to indicate maintenance of the components.
